(19) United States
(12) Patent Application Publication
(10) Pub. No.: US 2010/0207084 A1
(43) Pub. Date: Aug. 19, 2010

(54) Easy Binding Machine

(76) Inventor: Bei Wang, Dongguan (CN)

Correspondence Address: GLOBAL IP SERVICES, 7285 W. Eagle Court, Winton, CA, 95388, US

(21) Appl. No.: 12/402,762

(22) Filed: Mar. 12, 2009

(30) Foreign Application Priority Data
Feb. 13, 2009 (CN) 200920009617.4

(51) Int. Cl. B25B 25/00

(52) U.S. Cl. 254/199

(57) ABSTRACT

This invention discloses an easy binding machine. It mainly comprises: a main body, a scroll, a handle, a main lacing and an auxiliary lacing. The auxiliary lacing is in the rear side of the main body, and its tail is flexibly connected with the main body. There is an auxiliary hook fixed in the front end. There is an active buckle, which goes with the auxiliary lacing, in the rear of said main body. The said active buckle comprises a bottom board, left and right side walls and pin rolls. The pin roll is fixed between left and right side walls. There is a groove where corresponds to the pin roll in the bottom board. The tail of auxiliary reaches inside the active buckle from downward in the rear of active buckle's bottom board, and then circles the pin roll downward and reaches outside the active buckle through the groove on the bottom board. Since the auxiliary lacing and the main body are flexibly connected, the user can change auxiliary lacing and auxiliary hook freely as per the actual needs, which makes it more convenient to use the binding machine.

### CROSS REFERENCE TO THE RELATED PATENT APPLICATION

This patent application claims the priority of the Chinese patent application No. 200920009617.4 filed on Feb. 13, 2009, which application is incorporated herein by reference.

### FIELD OF THE INVENTION

This invention involves a binding machine, especially one used to tie down the objects, which can fixate and loosen the objects rapidly through rotating the handle.

### BACKGROUND OF THE INVENTION

The binding machine is widely used in the daily life with various models. One of the binding machines has two lacings, one main lacing with a hook and the other the auxiliary lacing. The main lacing tail, which can be tightened or loosened up by moving the handle, goes round the scroll of the binding machine. The auxiliary lacing is permanently connected with the horizontal beam on the tail section of the binding machine. Since the auxiliary lacing is permanently connected with the binding machine and the auxiliary is permanently linked with the auxiliary lacing, the user cannot change the auxiliary hook according to the actual needs and there is much inconvenience.

### SUMMARY OF THE INVENTION

This invention aims to eliminate the defects in existing binding machines and become a binding machine convenient for use. It can change its auxiliary lacing and auxiliary hook freely and is more convenient to use.

To realize the above purpose, this invention of binding machine comprises:

Main body: the left and right sides of said main body form a side plate, the front end forms a baffle plate; there is a hollow cavity formed between the side plate and the baffle plate.

The scroll: It is located within the hollow cavity, with left and right ends going through the side board.

The handle: It is above the top of main body. The side boards on its left and right ends are connected respectively with the left and right ends of the scroll.

Main lacing: The main lacing's rear circles the scroll and its front end reaches out from the leading groove in the middle of baffle plate, with a stabilized main hook.

Auxiliary lacing: It is located in the rear side of main body, with its tail connecting flexibly with the main body and the front end together with a stabilized auxiliary hook.

There is an active buckle going with the auxiliary lacing in the tail section of main body. The said active buckle comprises a bottom board, left and right side boards and a pin roll. The pin roll is fixed between left and right side walls. There is a groove where it is corresponding to the pin roll in the bottom board. The tail of auxiliary lacing reaches inside the active buckle from the downward in the rear of active buckle's bottom board, and then circles the pin roll from below and reaches outside the active buckle through the groove on the bottom board.

The front end of said main body is covered with a non-slip mat.

After adopting the above technical solution, this invention gains advantages in that: since the auxiliary lacing is connected flexibly with the main body, the user can replace auxiliary lacing and auxiliary hook freely according to the actual needs, which makes it more convenient to use.

### BRIEF DESCRIPTION OF THE DRAWINGS

The following further illustrates this invention with the attached drawings:

FIG. 1 is the overall structure diagram of this invention;

FIG. 2 is a connection schematic sketch for the auxiliary lacing of the invention;

FIG. 2 is a second connection schematic sketch for the auxiliary lacing of the invention;

FIG. 4 is a sectional structure sketch for connection between auxiliary lacing and active buckle.

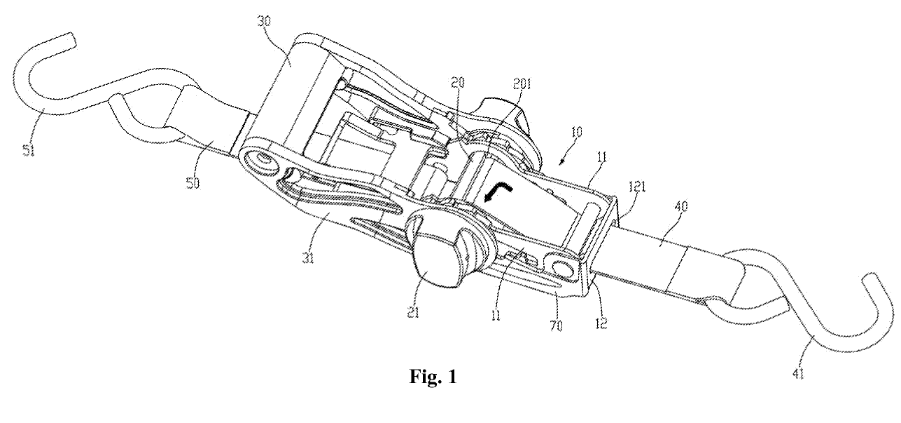

### DETAILED DESCRIPTION OF THE INVENTION

The following is a better example to execute this invention, which thus does not restrict the protective scope of this invention.

Please refer to what's shown in attached Drawing 1 to Drawing 4: this invention of binding machine comprises Main Body 10, a Scroll 20, a Handle 30, a Main Lacing 40, an Auxiliary Lacing 50, an Active Buckle 60 and a Non-Slip Mat.

Main Body 10 is made of steel board, with a level bottom board. The left and right sides of the bottom board curve up to form Side Plate 11. The front end forms Baffle Plate 12 with a leading Groove 121. A hollow cavity is formed between two Side Boards 11 and Baffle Plate 12. In addition, the front section of Main Body 10 is covered with Non-Slip Mat 70 made of soft plastic material in order to prevent scraping the surface of items that are tied by this binding machine. The front section of Main Body 10 is covered with Non-Slip Mat 70 which is made of soft plastic materials.

Scroll 20 is within the hollow cavity of Main Body 10. Its left and right ends go through Side Plate 11. There is a horizontal Directive Groove 201 that allows Main Lacing 40 to go through it in the middle. There is a plastic Knob 21 on either end of Scroll so that the user can retract and release Main Lacing 40 rapidly by directly rotating Scroll 20.

Handle 30 is over the top of Main Body 10. Side Plate 31 on its left and right ends is respectively connected with the two ends of Scroll 20, and it can rotate around the central axis of Scroll 20 back and forth.

The rear of Main Lacing 40 goes through the horizontal Directive Groove 201 in Scroll 20, and circles Scroll 20. Its front end reaches out from leading Groove 121 in the middle of Baffle Plate 12 and is fixated with a Main Hook 41.

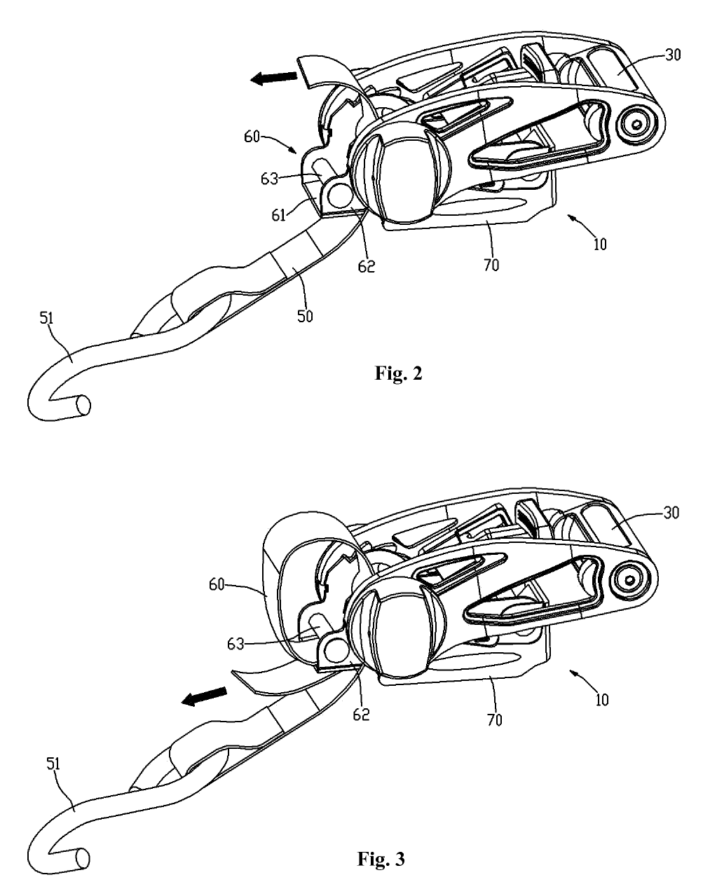

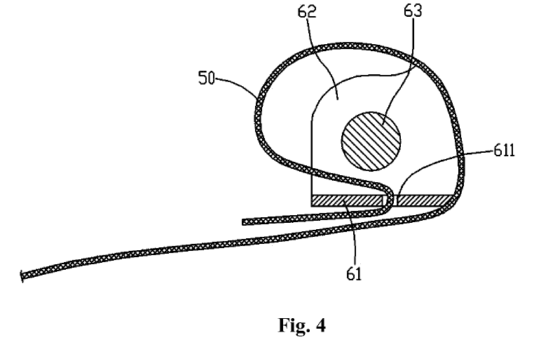

Auxiliary Lacing 50 is in the rear side of Main Body 10, and its tail is flexibly connected with Active Buckle 60 at the tail of Main Body 10. Its front end is fixed with an Auxiliary Hook 51. As shown in FIG. 2 to FIG. 4, Active Buckle 60 comprises Bottom Board 61, left and right Side Wall 62 and Pin Roll 63. Pin Roll 63 is fixated between left and right Side Walls 62. There is a Groove 611 where Bottom Board 61 corresponds to Pin Roll 63.

The tail of Auxiliary Lacing 50 goes inside Active Buckle 60 from downward in the rear of Active Buckle's Bottom Board 61, and then circles Pin Roll 63 from below to reach outside of Active Buckle 60 from Groove 611 in Bottom Board 61. When the front end of Auxiliary Lacing 50 is tightened, Active Buckle 60 can clasp the tail of Auxiliary Lacing 50 firmly, without loosen-off. When the user needs to change for an Auxiliary Hook of a different model, they can take off Auxiliary Lacing 51 according to the reverse steps of above assembly process. It is very convenient.

The other structure and operation principle, which are similar to those of existing binding machines, are not illustrated here.

1. A easy binding machine tying objects comprising:
a main body having a main body with a left side board and a right side board, the front end of the main body forming a baffle plate the left and right side boards and the baffle plate defining a hollow cavity;
a scroll being located within the hollow cavity, left and right ends of the scroll going through the side board;
a handle located above the top of the main body, the left and right side boards of the handle being connected with the left and right ends of the scroll respectively;
a main lacing, the rear of the main lacing circling the scroll and the front end of the main lacing reaching out through a leading groove in the middle of the baffle plate and being connected with a main hook;
an auxiliary lacing being located at the rear side of the main body, the tail of the auxiliary lacing being connected with the main body movably and the front end of the auxiliary lacing being connected with an auxiliary hook;
an active buckle located in the rear section of the main body for working in the auxiliary lacing, comprises a bottom board, a left and a right side boards and a pin roll, the pin roll is fixated between the left and right side boards of the active buckle the bottom board has a groove corresponding to the pin roll, the tail of the auxiliary lacing goes inside the active buckle from its rear, then goes round the pin roll, then reaches out of the active buckle from the groove.

2. (canceled)

3. The easy binding machine of claim 1, wherein the front end of the main body, which touches tied items, is covered with a plastic non-slip mat to prevent scraping surfaces of the tied items.
